(19) United States
(12) Patent Application Publication
(10) Pub. No.: US 2018/0271033 A1
(43) Pub. Date: Sep. 27, 2018

(54) LANDSCAPING FABRIC HAVING ENHANCED MECHANICAL PROPERTIES

(71) Applicant: EASY GARDENER PRODUCTS, INC. dba The Jobe's Company, Waco, TX (US)

(72) Inventor: Douglas E. Austin, Waco, TX (US)

(73) Assignee: EASY GARDENER PRODUCTS, INC. dba The Jobe's Company, Waco, TX (US)

(21) Appl. No.: 15/890,995

(22) Filed: Feb. 7, 2018

Related U.S. Application Data
(60) Provisional application No. 62/474,952, filed on Mar. 22, 2017.

(51) Int. Cl. A01G 13/02; D04H 1/724; D04H 3/16

(52) U.S. Cl. CPC A01G 13/0268; D10B 2505/204; D04H 3/16; D04H 1/724

(57) ABSTRACT

A method of making gardening fabric includes melting a polymer and processing the melted polymer, drawing the processed polymer into filaments, forming a web from the filaments, and autogenously bonding the web to form the gardening fabric as a nonwoven fabric sheet. The autogenous bonding includes forming a pattern into the nonwoven fabric sheet, the pattern being formed by areas of the nonwoven fabric sheet that exhibit a higher degree of fusion than other areas. The pattern may include a lattice forming a plurality of identically sized geometric areas of the bonded fibers, and the lattice is formed by areas of the bonded fibers that exhibit a higher degree of fusion than the identically sized geometric areas. The pattern may include a lattice forming a plurality of identically sized s-shaped areas of the bonded fibers, or a lattice forming a plurality of randomly shaped and sized non-geometric shapes.

### CROSS REFERENCE TO RELATED APPLICATIONS

This application claims the benefit of and priority to U.S. Provisional Patent Application No. 62/474,952, filed on Mar. 22, 2017, the contents of which are incorporated herein by reference in its entirety.

### TECHNICAL FIELD

This disclosure is related to landscaping fabric, and in particular, to a landscaping fabric having enhanced mechanical properties resulting from a pattern formed onto the fabric through autogenous bonding.

### BACKGROUND

Certain landscape fabrics are used for a variety of landscaping applications, such as deterring growth of undesirable vegetation, providing erosion control, and the like. After a landscaped bed is prepared with proper soil and drainage, the landscape fabric is placed over the bed and cut to any configuration of the bed. It is typically staked in place with staples or spikes to prevent movement. Holes may then cut in the fabric at points where plants are desired, and the plants (e.g., trees, bushes, and perennials) are then planted through the fabric openings or holes and into the soil. The fabric is then covered by several inches of wood mulch, gravel or rocks, and in the case of crops such as strawberries or tomatoes. tucked into the sides of the plant bed.

Such prior art landscape fabrics may be made of solid flat plastic sheets, which are undesirable because although they may block weed growth and promote erosion control, the solid plastic sheets do not allow air and water to penetrate the sheet and flow through to the underlying soil. Indeed, such solid plastic sheets may result in poor growing conditions and mold as the soil is not allowed to “breathe” and water is not allowed to reach plant roots.

To address these issues, landscape fabrics have been constructed from fibers. These fiber based landscape fabrics allow air and water passage but still serve to deter weed growth and provide erosion control. However, such fiber based landscape fabrics are not without their own drawbacks. For example, the tensile strength of such fiber based landscape fabrics may be lower than desired, leading to scenarios where the fabrics may rip during installation, or during routine landscape maintenance. Additionally, such fiber based landscape fabrics may have a lower puncture resistance than desired, resulting in punctures either during installation, during routine landscape maintenance, or from growing plants themselves.

Accordingly, there is a commercial need for the development of fiber based landscape fabrics having enhanced mechanical properties that address the above noted limitations of prior art fiber based landscape fabrics.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Disclosed herein is a gardening fabric including a nonwoven fabric sheet of bonded fibers, with a pattern formed into the nonwoven fabric sheet. The pattern is formed by areas of the bonded fibers that exhibit a higher degree of fusion than other areas.

In some cases, the pattern may be a lattice forming a plurality of identically sized geometric areas of the bonded fibers, with the lattice being formed by areas of the bonded fibers that exhibit a higher degree of fusion than the identically sized geometric areas. This lattice may form a honeycomb pattern. The identically sized geometric areas may in some cases be hexagonal in shape or elliptical in shape.

The pattern may be a lattice forming a plurality of identically sized s-shaped areas of the bonded fibers, with the lattice being formed by areas of the bonded fibers that exhibit a lesser degree of fusion than the identically sized s-shaped areas.

In some cases, the pattern may be a lattice forming a plurality of randomly shaped and sized non-geometric shapes, with the lattice being formed by areas of the bonded fibers that exhibit a lesser degree of fusion than the plurality of randomly shaped and sized non-geometric shapes.

The nonwoven fabric may be an autogenously-bonded nonwoven composite fabric in some cases, or may be a spunbond fabric.

Also disclosed herein is a method of making gardening fabric. The method includes melting a polymer and processing the melted polymer, drawing the processed polymer into filaments, forming a web from the filaments, and autogenously bonding the web to form the gardening fabric as a nonwoven fabric sheet. The autogenous bonding includes forming a pattern into the nonwoven fabric sheet, with the pattern being formed by areas of the nonwoven fabric sheet that exhibit a higher degree of fusion than other areas.

The pattern may be a lattice forming a plurality of identically sized geometric areas of the bonded fibers, with the lattice itself being formed by areas of the bonded fibers that exhibit a higher degree of fusion than the identically sized geometric areas. The lattice may form a honeycomb pattern. The identically sized geometric areas may be hexagonal in shape, or may be elliptical in shape.

The pattern may be a lattice forming a plurality of identically sized s-shaped areas of the bonded fibers, with the lattice being formed by areas of the bonded fibers that exhibit a lesser degree of fusion than the identically sized s-shaped areas.

The pattern may be a lattice forming a plurality of randomly shaped and sized non-geometric shapes, with the lattice being formed by areas of the bonded fibers that exhibit a lesser degree of fusion than the plurality of randomly shaped and sized non-geometric shapes.

The polymer may be formed polypropylene, polyester, nylon, polyethylene, polyurethane, and/or rayon.

Also disclosed herein is a method of improving mechanical properties of landscape fabric. The method includes forming a sheet of unimproved landscape fabric using a spunbond process. The method also includes fusing areas of the sheet of unimproved landscape fabric to form a lattice in the sheet of unimproved landscape fabric, thereby transforming the unimproved landscape fabric into landscape fabric having improved mechanical properties.

Fusing of the areas of the sheet of unimproved landscape fabric is performed using a heated roller having the lattice embossed thereon. The mechanical properties improved are grab tensile break, grab tensile elongation, puncture, tap tear, and water channeling.

The lattice may form a plurality of identically sized geometric areas on the landscape fabric having the improved mechanical properties, with the lattice itself being formed by areas of the landscape fabric having the improved mechanical properties that exhibit a higher degree of fusion than the identically sized geometric areas.

The lattice may form a plurality of identically sized geometric areas on the landscape fabric having the improved mechanical properties, with the lattice itself being formed by areas of the landscape fabric having the improved mechanical properties that exhibit a lesser degree of fusion than the identically sized geometric areas.

### BRIEF DESCRIPTION OF THE DRAWINGS

FIG. 1 is a front view of a roll of landscaping fabric having a pattern of s-shaped shapes formed thereon in accordance with this disclosure.

FIG. 2 is a front view of a roll of landscaping fabric having a honeycomb pattern formed thereon in accordance with this disclosure.

FIG. 3 is a front view of a roll of landscaping fabric having a pattern of elliptical shapes formed thereon in accordance with this disclosure.

FIG. 4 is a front view of a roll of landscaping fabric having a pattern of random sized and spaced shapes formed thereon in accordance with this disclosure.

FIG. 5 is a flowchart of a method of forming the landscaping fabrics described herein.

### DETAILED DESCRIPTION

One or more embodiments of the present disclosure will be described below. These described embodiments are only examples of the presently disclosed techniques. Additionally, in an effort to provide a concise description, some features of an actual implementation may not be described in the specification. When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements.

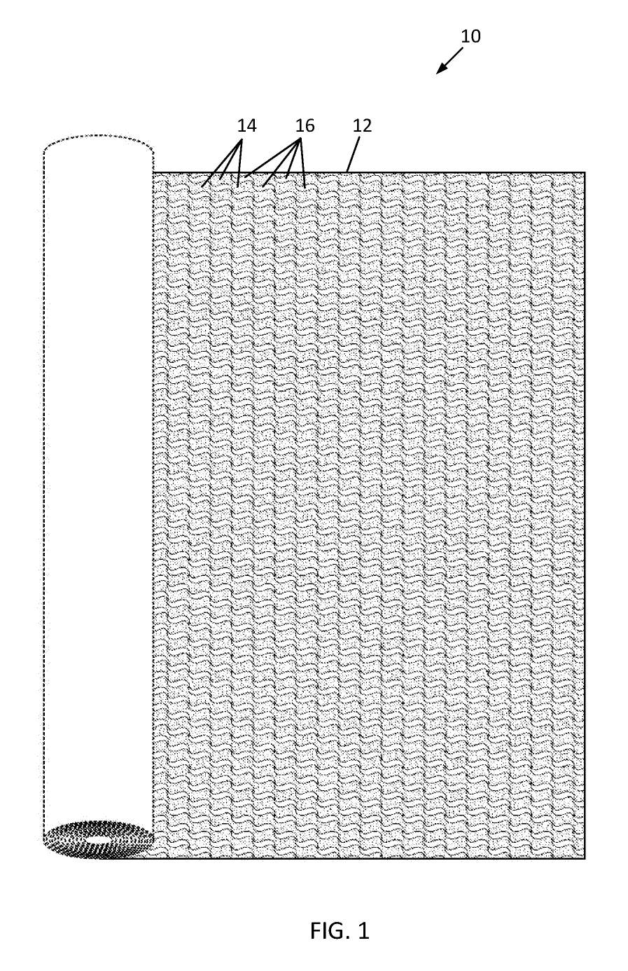

With initial reference to FIG. 1, a landscaping fabric 10 is now described. The landscaping fabric 10 is a nonwoven fabric sheet 12 comprises of bonded fibers. The nonwoven fabric sheet 12 itself may be comprised solely of, or of any combination of, bonded fibers of polypropylene, polyester, nylon, polyethylene, polyurethane, rayon, or other suitable polymer materials.

A pattern is formed on the nonwoven fabric sheet 12. The pattern is formed by areas 16 of the nonwoven fabric sheet 12 that have been treated or processed such that their fibers exhibit a higher degree of fusion than other areas 14. This pattern may take any number of suitable forms. For example, as shown in FIG. 1, the pattern may be comprised of s-shaped curves 16 formed from fibers that exhibit a higher degree of fusion than other areas 14 of the nonwoven fabric sheet 12.

The pattern formed on the nonwoven fabric sheet 12 imparts the landscaping fabric 10 with enhanced mechanical properties. The inventors have found the exemplary patterns described herein to impart enhanced grab tensile break, grab tensile elongation, puncture resistance, and tap tear resistance properties on the fabric sheet. This advantageously helps to ward against rips and tears during installation and during routine landscape maintenance operations. This also helps ward against rips and tears caused by growing vegetation. Depending on the specific pattern used, certain of these mechanical properties may be more enhanced than others, making certain patterns more suitable for certain landscaping installations or applications than others. In addition, depending on the specific pattern used, different advantageous water channeling properties may be present.

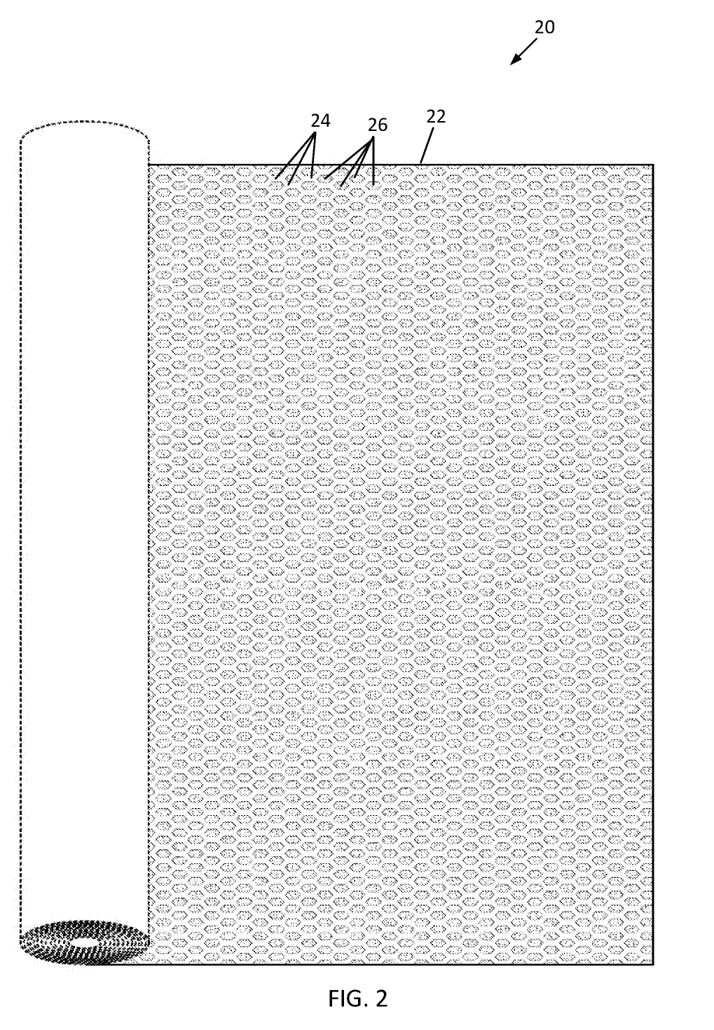

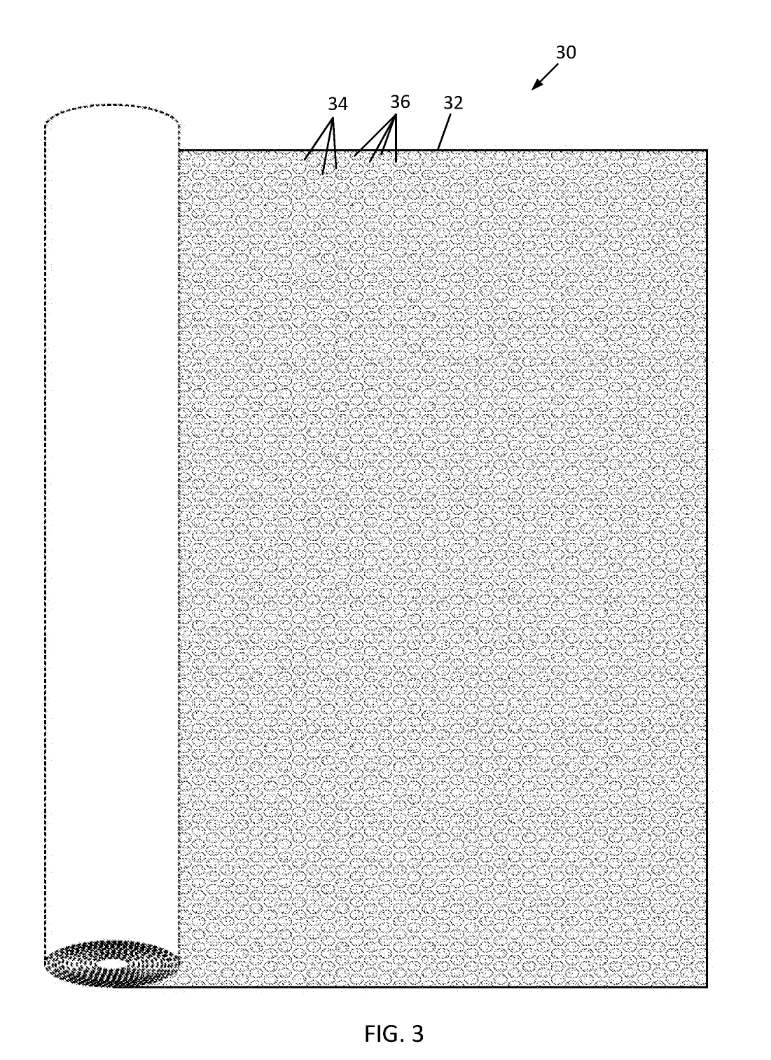

As another example of patterns that may be used, as shown on the nonwoven fabric sheet 22 of FIG. 2, the pattern may be comprised of a lattice 26 forming multiple identically sized geometric areas 24, such as a honeycomb shape. As also shown in FIG. 2, the lattice 26 may have fibers exhibiting a higher degree of fusion than the geometric areas 24, although the converse may be true in some cases. The geometric areas 26 may be polygonal in shape, such as hexagonal, as shown in FIG. 2. In other cases such as shown on the nonwoven fabric sheet 32 of FIG. 3, these geometric areas 36 may be elliptical in shape.

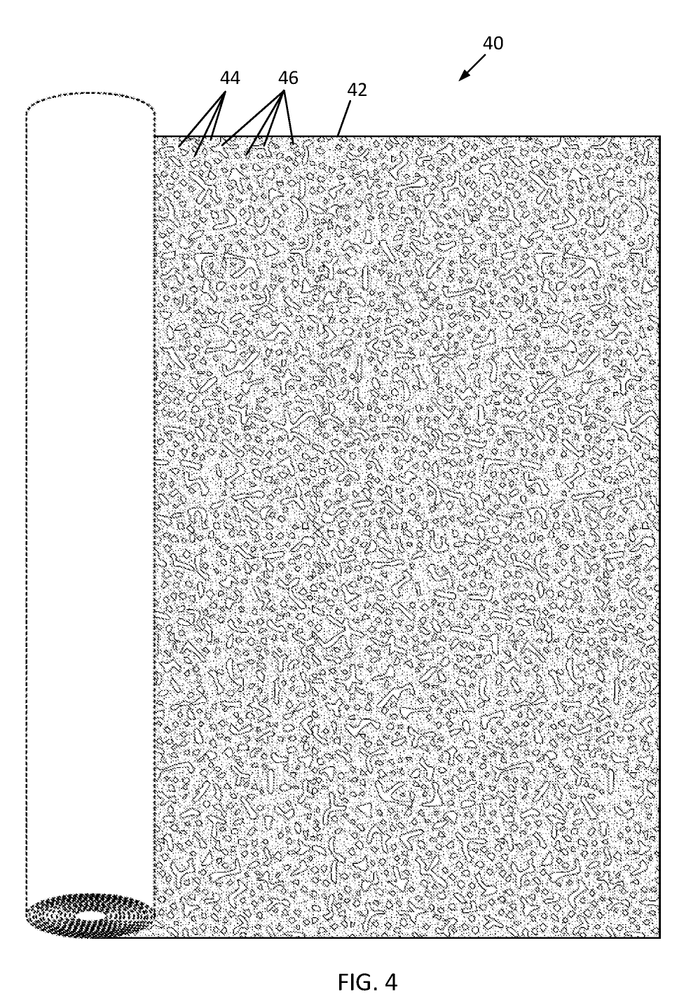

In still further cases, such as shown on the nonwoven fabric sheet 42 of FIG. 4, the pattern may be comprised of areas of randomly sized and spaced shapes 46, the fibers of which exhibit a higher degree of fusion than surrounding areas 44. These shapes 46 may in some cases be randomly sized but not randomly spaced, or randomly spaced but not randomly sized. In addition, “random” as used here may refer the shapes in a specific area of the nonwoven fabric sheet 42, and that area itself may be repeated to form the overall pattern on the nonwoven fabric sheet. The various portions of the various patterns described above may be identically sized, identically shaped, and identically spaced in some situations, as will be appreciated by those of skill in the art.

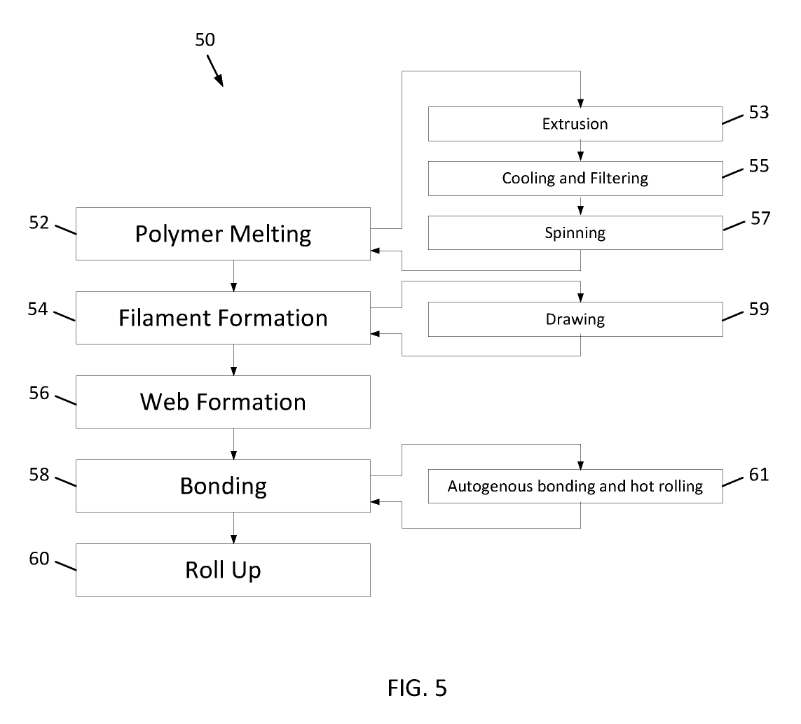

A method of forming the landscaping fabrics described herein is now described with reference to flowchart 50 of FIG. 5. Initially, a polymer is melted and processed (Block 52). This melting and processing includes extruding the polymer through a desired die shape (Block 53), and then cooling and filtering the extruded polymer (Block 55). The cooled and filtered polymer is then spun (Block 57), and then filaments or fibers are formed from the polymer (Block 54). This filament or fiber formation is performed by drawing the polymer (Block 59).

The filaments or fibers are then laid into a web (Block 56). During this web laying process, the filaments or fibers may be separated by air jets or electrostatic charges. Thereafter, a bonding process is performed (Block 58) to form a nonwoven fabric sheet. This bonding process is an autogenous bonding process (Block 61) and includes feeding the web through a series of hot rollers having the pattern formed (i.e. embosses or debossed) thereon. The pattern being formed on the hot rollers results in the formation of the pattern having the characteristics and properties described above. The resulting autogenously bonded nonwoven fabric sheet is then rolled up (Block 60) or otherwise prepared and packaged for purchase or use.

In some cases, instead of hot rollers, hot needles may be used instead, as well as any suitable mechanical bonding, thermal bonding, or chemical bonding techniques. Specific stages of area and point bonding may be used as well. In some cases, stitch bonding, ultrasonic fusing, and hydraulic entanglement may be used for the bonding process.

In addition, in some cases, the polymer(s) used (i.e. polypropylene, polyester, nylon, polyethylene, polyurethane, or rayon) may be mixed with lower melting point materials. Further, in some cases, the materials used may be combinations of higher melting point polymers and lower melting point polymers, which ultimately form bi-component fibers where the lower melting point polymers form sheathes of material around the higher melting point polymers.

In addition to the techniques described above for formation, the landscaping fabrics described herein may be formed via a spunbond process, or via related systems such as the docan system, reicofil system, or lutravil system.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. A gardening fabric comprising:
a nonwoven fabric sheet comprised of bonded fibers;
a pattern formed into the nonwoven fabric sheet, the pattern being formed by areas of the bonded fibers that exhibit a higher degree of fusion than other areas.

2. The gardening fabric of claim 1, wherein the pattern comprises a lattice forming a plurality of identically sized geometric areas of the bonded fibers, the lattice being formed by areas of the bonded fibers that exhibit a higher degree of fusion than the identically sized geometric areas.

3. The gardening fabric of claim 2, wherein the lattice forms a honeycomb pattern.

4. The gardening fabric of claim 2, wherein the identically sized geometric areas are hexagonal in shape.

5. The gardening fabric of claim 2, wherein the identically sized geometric areas are elliptical in shape.

6. The gardening fabric of claim 1, wherein the pattern comprises a lattice forming a plurality of identically sized s-shaped areas of the bonded fibers, the lattice being formed by areas of the bonded fibers that exhibit a lesser degree of fusion than the identically sized s-shaped areas.

7. The gardening fabric of claim 1, wherein the pattern comprises a lattice forming a plurality of randomly shaped and sized non-geometric shapes, the lattice being formed by areas of the bonded fibers that exhibit a lesser degree of fusion than the plurality of randomly shaped and sized non-geometric shapes.

8. The gardening fabric of claim 1, wherein the nonwoven fabric sheet is an autogenously-bonded nonwoven composite fabric sheet.

9. The gardening fabric of claim 1, wherein the nonwoven fabric is spunbond fabric.

10. A method of making gardening fabric comprising:
melting a polymer and processing the melted polymer;
drawing the processed polymer into filaments;
forming a web from the filaments;
autogenously bonding the web to form the gardening fabric as a nonwoven fabric sheet;
wherein the autogenous bonding includes forming a pattern into the nonwoven fabric sheet, the pattern being formed by areas of the nonwoven fabric sheet that exhibit a higher degree of fusion than other areas.

11. The method of claim 10, wherein the pattern comprises a lattice forming a plurality of identically sized geometric areas, the lattice being formed by areas of the nonwoven fabric sheet that exhibit a higher degree of fusion than the identically sized geometric areas.

12. The method of claim 11, wherein the lattice forms a honeycomb pattern.

13. The method of claim 11, wherein the identically sized geometric areas are hexagonal in shape.

14. The method of claim 11, wherein the identically sized geometric areas are elliptical in shape.

15. The method of claim 10, wherein the pattern comprises a lattice forming a plurality of identically sized s-shaped areas, the lattice being formed by areas of the nonwoven fabric sheet that exhibit a lesser degree of fusion than the identically sized s-shaped areas.

16. The method of claim 10, wherein the pattern comprises a lattice forming a plurality of randomly shaped and sized non-geometric shapes, the lattice being formed by areas of the nonwoven fabric sheet that exhibit a lesser degree of fusion than the plurality of randomly shaped and sized non-geometric shapes.

17. The method of claim 10, wherein the polymer is comprised of at least one material from the group consisting of polypropylene, polyester, nylon, polyethylene, polyurethane, and rayon.

18. A method of improving mechanical properties of landscape fabric comprising:
forming a sheet of unimproved landscape fabric using a spunbond process;
fusing areas of the sheet of unimproved landscape fabric to form a lattice in the sheet of unimproved landscape fabric, thereby transforming the sheet of unimproved landscape fabric into landscape fabric having improved mechanical properties.

19. The method of claim 18, wherein fusing the areas of the sheet of unimproved landscape fabric is performed using a heated roller having the lattice embossed thereon.

20. The method of claim 18, wherein the mechanical properties improved are grab tensile break, grab tensile elongation, puncture, tap tear, and water channeling.

21. The method of claim 18, wherein the lattice forms a plurality of identically sized geometric areas on the landscape fabric having the improved mechanical properties, the lattice being formed by areas of the landscape fabric having the improved mechanical properties that exhibit a higher degree of fusion than the identically sized geometric areas.

22. The method of claim 18, wherein the lattice forms a plurality of identically sized geometric areas on the landscape fabric having the improved mechanical properties, the lattice being formed by areas of the landscape fabric having the improved mechanical properties that exhibit a lesser degree of fusion than the identically sized geometric areas.
